(19) United States
(12) Patent Application Publication
(10) Pub. No.: US 2007/0226084 A1
(43) Pub. Date: Sep. 27, 2007

(54) Electronic product catalog for organizational electronic commerce

(76) Inventor: Roger E. Cowles, Philadelphia, PA (US)

Correspondence Address: D-NET CORPORATION;ATTN: ROGER E. COWLES, P.O. BOX 42546, PHILADELPHIA, PA, 19101, US

(21) Appl. No.: 11/789,994

(22) Filed: Apr. 26, 2007

Related U.S. Application Data
(63) Continuation of application No. 09/534,453, filed on Mar. 24, 2000.

(51) Int. Cl. G06F 19/00

(52) U.S. Cl. 705/27

(57) ABSTRACT

A networked data processing system (D-NET) facilitates and conducts secure electronic commerce based on national deployment independent of the Internet. A “publish and subscribe” model is used in which vendors publish catalogs and information about product and service offerings to D-NET applications which utilize an electronic product/service database with predefined structures. Subscribing organizations may then browse and search the vendor data using database queries, search engines and agents. Buyers and sellers may communicate directly using and integrated messaging service. Buyers may obtain quotations from sellers and calculate the total landed (delivered) cost of goods prior to purchase. Buyers may place blanket and standard purchase orders and track shipments to destination. Sellers receive payment electronically for goods and services. Orders for goods and services may be translated to XML or EDI formats and transmitted directly to seller order processing systems or serve as input to standard or customized supply chain management applications hosted at D-NET sites.

### CROSS-REFERENCE TO RELATED APPLICATIONS

The present application is a continuation patent application which claims priority from U.S. patent application Ser. No. 09/534,453 filed Mar. 24, 2000 and incorporated herein by reference in its entirety.

### FIELD OF THE INVENTION

The present invention relates to data processing systems, and more particularly, to international electronic commerce using electronic catalogs and automated processes to identify products selected for potential purchase and to calculate delivered costs of goods and services.

### BACKGROUND OF THE INVENTION

Advancements in computer technology and digital communications have made it possible for corporations and organizations to conduct commerce electronically (e-commerce) using public or private networked computer systems. Such systems may generally provide a WWW (world-wide web) server for customer or clients to execute transactions. There are presently no uniform standards for e-commerce, and thus there are many technical differences and inconsistencies between the data presentation, data organization, data content, databases and communication methods used in each of the systems used for e-commerce. As a result, it is largely impossible at the present time to conduct true “any to any” (buyer to seller) electronic commerce.

“Any to any” e-commerce is defined here as the capability of any known or unknown commercial or government organization to electronically complete all of the processes to identify, select, purchase and pay for any product or service advertised or offered by a previously known or unknown seller, where such orders and/or RFPs are subject to final acceptance by the seller.

Technologies currently existing to replace paper-based document exchange with electronic document exchange such as Extensible Markup Language (XML), Electronic Data Interchange (EDI), World-Wide-Web (WWW applications and extranets may require all trading partners be identified and in virtually all cases to adopt the same applications and use the same network, such as the Internet. These technologies do not lend themselves to open “any-to-any” electronic commerce because they typically use WWW-based languages such as hypertext markup language (HTML), XML or other derivatives where no implementations are exactly alike, making open “any-to-any” e-commerce very difficult or impossible.

Furthermore, the large number of Internet and WWW-based proprietary and custom e-commerce software products deployed may be so great that worldwide interoperability between these systems may be very difficult or impossible. Such impediments are further greatly magnified in international commerce when currency, linguistic, tariff, trading partner, export control, trading bloc and other variables are added.

The Internet is by definition an unmanaged “network of networks” growing spontaneously worldwide. The primary Internet service, the World-Wide-Web, and WWW languages such as XML and HTML were created for document search/retrieval applications rather than e-commerce. The various XMUHTML standards and varying implementations at sites worldwide, along with thousands of proprietary e-commerce software products, make international electronic commerce very difficult and “any-to-any” e-commerce impossible.

Furthermore, most changes in important variables for international commerce such as tariffs, exchange rates and export controls are determined on a national level. Widely dispersed, Internet site-based e-commerce systems have no way to immediately recognize and update the data available to commerce applications to reflect these changes. In addition, it may be prohibitively expensive to establish and maintain an Internet-based e-commerce website, so it may be more cost-effective for a small or medium-sized organization to utilize a publish-and-subscribe e-commerce model such as that described herein.

Thus, a clear need exists in the art for a new data processing architecture based on national (country) deployment designed from the ground up to enable governments, organizations and entities located in each country to locate goods and services worldwide, to engage in a full range of purchasing and supply-chain activities, and to receive payment by electronic funds transfer.

### SUMMARY OF THE INVENTION

A new, integrated, networked data processing system (D-NET) is designed specifically to enable “any to any” e-commerce for subscribing organizations worldwide by means of national implementation, (i.e., with subscribing organizations connected to a site in their respective country). The system is designed specifically to enable “any to any” e-commerce between organizations and entities located in different countries.

The present invention operates within the aforementioned D-NET system by enabling manufacturers, brokers, exporters, forwarders and “end-user” organizations in each country to locate and purchase goods and services using country of origin, standard classification codes, agents, search engines and database queries. Subscribers to this system may also receive automated responses from D-NET applications, such as the availability or prices of certain products, or when pre-determined purchase conditions such as price are met.

D-NET will comprise a minimum of one computer site in each country to which subscribing organizations connect. D-NET applications will provide multi-level access to product/service information depending upon existing trading partner agreements, tariffs, export controls and customer/order characteristics. D-NET may support two core applications: a “Virtual Open Trading Extranet” application designed to provide “any to any” (seller to buyer) e-commerce and a “National Procurement and Resource Management” application designed to enable the electronic procurement of goods and services by national, regional and local governments.

The D-NET system and these applications utilize and are dependent upon the present invention: the first commercial electronic catalog with a structured, extensible database structure that may accommodate any type of good or service. Vendor sellers may publish their product/service data to this system using a “fill-in-the-template” data entry method for text and graphics; as this system provides predefined database structures. This system eliminates the need to author, manage and update Internet website XML or HTML pages for e-commerce.

A D-NET subscriber computer running commercially available browser software may view, enter and retrieve data from D-NET applications over the Internet. However, such functions are not dependent upon the Internet and do not require authoring or maintaining XML/HTML pages at a subscriber location.

The terms “Virtual Open Trading Extranet”, “National Procurement and Resource Management System” and “D-NET” are used and described herein for the first time.

The present invention makes use of a “publish and subscribe” model, in which seller vendors may publish their product and service information with multilevel pricing and additional information to D-NET applications hosted at national (country) data processing sites. Buyers and sellers may communicate directly using an integrated messaging system and a series of D-NET documents that will conform to emerging e-commerce document standards.

The present invention, by implementing extensible database structures, enables buyers to obtain quotations from sellers and to calculate the total landed (delivered) cost of goods prior to purchase. Buyers may place blanket and standard purchase orders and track order shipments to destinations. Sellers receive payment electronically for goods and services. Orders for goods and services may be translated to XML or EDI format by D-NET applications and transmitted directly to Seller order processing systems or serve as input to standard or customized supply chain management applications hosted at D-NET sites.

D-NET national sites may be directly connected in a “point-to-point” or “mesh” network over which data is replicated and transmitted. This functionality enables a buyer, who may be previously unknown to seller, to located desired goods and services, obtain pricing and shipping information, and to place orders which are either transmitted directly to seller or a supply chain application hosted on a D-NET site for processing and fulfillment.

Another objective of the present invention is to facilitate business-to-business e-commerce by reducing the number of data errors created when multiple systems are used.

Another objective of the present invention is to facilitate e-commerce in countries where deployment of the Internet is problematic, or where such use is regulated or restricted by national governments.

Exporters, manufacturers, distributors, brokers and sellers will subscribe to one or more D-NET applications and publish their product/service information to a database on a D-NET site which utilizes the predefined database structures described herein. Using database replication techniques the system serves as a worldwide distributed database containing all of the vendor catalog data. Importers, brokers and buyers subscribe to the system and may then search for products, goods and services using country of origin, standard classification codes, product characteristics, pricing characteristics, availability and other purchasing criteria.

### BRIEF DESCRIPTION OF THE DRAWINGS

The novel and non-obvious characteristics and nature of the invention are set forth in the appended claims. The operation of the invention is best understood by reference to the detailed description of specific embodiments which follow, when reviewed in conjunction with the accompanying drawings, wherein:

FIG. 1 is a top-level diagram depicting a logical three-tier information processing architecture deployed in two national sites with nodes, backbone, subscriber connections, and links to Government Agencies and electronic funds transfer.

FIG. 2 is a UML (Unified Modeling Language) diagram of the high-level data model constructed to support the following functions of the Electronic Product Catalog: Order Management, Address Structure, External Interfaces, Extensible Product Attributes and Price Lists, Buyer and Seller Preferences and Multilingual Support. FIG. 2 provides a definition of the structure of all the data contained by the Electronic Product Catalog.

FIG. 3 is a UML diagram of the Order Management data structure of the Electronic Product Catalog.

FIG. 4 is a UML diagram of the Address data structure of the Electronic Product Catalog.

FIG. 5 is a UML diagram of the External Interfaces data structure of the Electronic Product Catalog.

FIG. 6 is a UML diagram of the Product Attributes/Price List data structure of the Electronic Product Catalog.

FIG. 7 is a UML diagram of the Buyer/Seller Preferences data structure of the Electronic Product Catalog.

FIG. 8 is a UML diagram of the Multilingual Support data structure of the Electronic Product Catalog.

FIG. 9 is a UML diagram of the primary Data Types supported by the Electronic Product Catalog.

### DETAILED DESCRIPTION OF THE INVENTION

The present invention is implemented within a distributed computing architecture based on national deployment (i.e., with at least one site located in each participating country and executing algorithms only on servers at each national site utilizing the rules, laws, trading partner agreements and tariffs governing electronic commerce transactions). The backbone consists of a mesh pattern network, hereinafter referred to as D-NET, with dedicated redundant communication links between sites. WWW-based subscriber clients may use the Internet to connect to a site in their country. Subscriber clients may also use a Microsoft® Windows™ client computer to connect to a D-NET site using a public or private circuit.

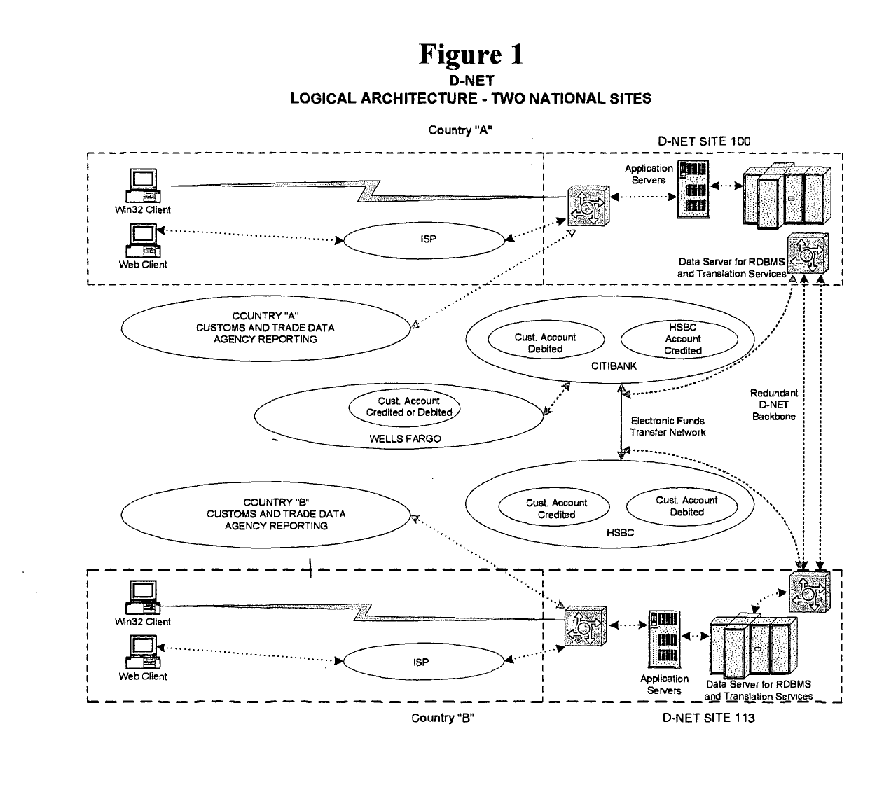

Referring now to FIG. 1, there is shown a top-level functional block diagram illustrating a logical three-tier architecture deployed in two national sites with nodes, backbone, subscriber connections, links to Government Agencies and electronic funds transfer.

Each national site has one or more WWW browser clients 104 and/or Microsoft® Windows™ clients 101 connected to an application or WWW server 102 through an Internet Service Provider (ISP), leased-line, wireless, dial-up, ISDN or other public or private circuit as well as routers, bridges, switches and the like. WWW server 102 may comprise multiple servers networked together. Application server(s) 102 are similarly connected to a mainframe-class data server 103.

National site A 124 (in this example, a buyer site) may be connected to national site B 126 (in this example, a seller site) through a redundant backbone between routers, switches or the like 110 and 134 at national sites A and B respectively. Router 110 also connects to buyer bank 116 and International Trade Data System (ITDS) 120. Buyer bank 116 may connect to seller bank 132 through a Society for Worldwide Interbank Financial Telecommunications (SWIFT) network and to another bank 122 (e.g., Wells Fargo) to process a Fedwire credit or debit. Buyer bank 116 may maintain customer account debit information 114 and seller bank 132 account credit information 112.

Router 134 may connect to a seller bank 132 and customs and trade data agency 118. Seller bank 132 may maintain customer account credit information 128 and buyer bank 116 account debit information 130.

Country specific business logic such as tariffs and trading bloc rules may be executed in computer code on application servers 102 and data servers 102. Internet web based clients 104 may connect to a WWW or application server 102 at the national site, which uses a common gateway interface (CGI) script or similar method to translate requests to structured query language (SQL) queries and statements.

Data servers 103 may maintain object-relational database tables containing all of the vendor, buyer and catalog data. Database replication techniques may be used to ensure transaction and distributed database integrity between national sites A and B 124 and 126 respectively. Data servers 103 may perform data translation to EDI and XML formats when necessary. The database may be object-relational.

The Distributed Computing Environment Security Service may be used to authenticate subscribers and connections, provide authorization to applications and protect transmitted data. Both the WWW browser and Microsoft® Windows™ clients may be Distributed Computing Environment (DCE) clients. The most likely authentication configuration is single sign-on, in which a subscribing user logs in to a DCE security server (which may reside on the application/WWW servers 102, data servers 103 or a separate server not shown) and may subsequently access all authorized applications without the need for additional logins. DCE services are referenced to provide a complete and full description of the D-NET architecture.

In an authorization configuration for personal computer-based (workstation class) clients, subscribing users register in one or more groups that enjoy varying access privileges based on DCE access control lists (ACLs). ACLs contain lists of entries describing the explicit access permissions granted to users and groups.

IP Security (IPSec) may be used for encryption and data integrity of data transmitted across the D-NET backbone.

WWW browser clients may employ an authentication browser plug-in and session manager module to receive credentials for a DCE transaction from a D-NET DCE web server. Secure Sockets Layer (SSL) may be used to encrypt transaction data between the browser client and D-NET server.

A DCE configuration for both browser-class and workstation-class clients is to login to a DCE-based security server where all security-related information is stored.

Remote access, such as dial-up access, may be provided to applications from Microsoft® Windows™ and web based browser clients that support the Point-to-Point (PPP) or Layer 2 Tunneling Protocol (L2TP).

This system may provide two core applications to subscribing organizations: the Virtual Open Trading Extranet (VOTE) and National Procurement and Resource Management (NPRM). VOTE is offered to commercial organizations while NPRM is offered only to government agencies.

VOTE is an application that may enable any subscribing buyer to engage in a full range of purchasing activities for any product or service published on the system to the Electronic Product Catalog by sellers, brokers, exporters or manufacturers worldwide, even if previously unknown to the seller.

This is referred to as “any-to-any” electronic commerce. An Electronic Product Catalog is defined herein for the first time to enable “any-to-any” electronic commerce. The invention of an Electronic Product Catalog provides and defines a standard, common database schema that sellers, brokers, manufacturers or exporters may use to publish their product or service catalogs to the system. The term “schema” is used herein to mean a collection of database table definitions and related objects including tables, views, stored procedures, indexes, clusters and database links. Sellers, brokers, manufacturers and exporters who publish their product or service catalogs to the Electronic Product Catalog may restrict the viewing of part of all of the catalog contents to buyers based on variables such as the country of origin of the buyer.

The invention of the Electronic Product Catalog makes it unnecessary for sellers, brokers, manufacturers and exporters to create and maintain their own individual, separate electronic product catalogs. This method is considered “state-of-the-art” currently. Furthermore, said Electronic Product Catalog facilitates international electronic commerce by maintaining all seller product and service catalog data in a single, standardized database schema with associated classification codes. This enables buyers to rapidly search for and locate desired products or services without having to be concerned with different electronic catalog formats, product/service descriptions, classification codes and price lists. Said Electronic Product Catalog also facilitates international commerce by maintaining all seller pricing data, enabling buyers to obtain, with one query, the total landed (delivered) cost for a desired quantity of a product or service from a seller. It allows the buyer to compare this total landed cost to that calculated by the system for the same potential order from other sellers in the same or different countries.

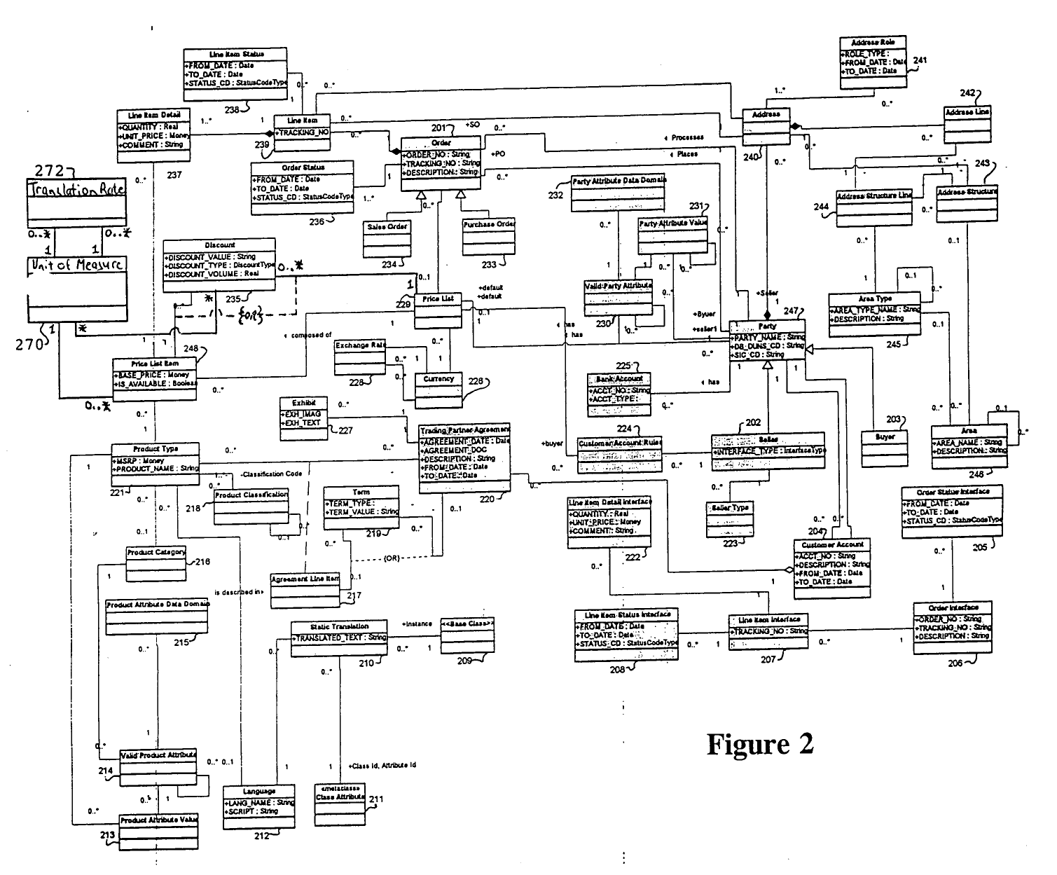

FIG. 2 is a unified modeling language (UML) class diagram illustrating the high-level data model of the Electronic Product Catalog. UML diagrams may be used to model complex software systems. UML class diagrams may generally be used to model object-oriented software systems by graphically illustrating object classes and their relationships.

The data structures of the Electronic Product Catalog support the following functions and features: Order Management, Address Structure, External Interfaces, Extensible Product Attributes and Price Lists, Buyer and Seller Preferences and Multilingual Support.

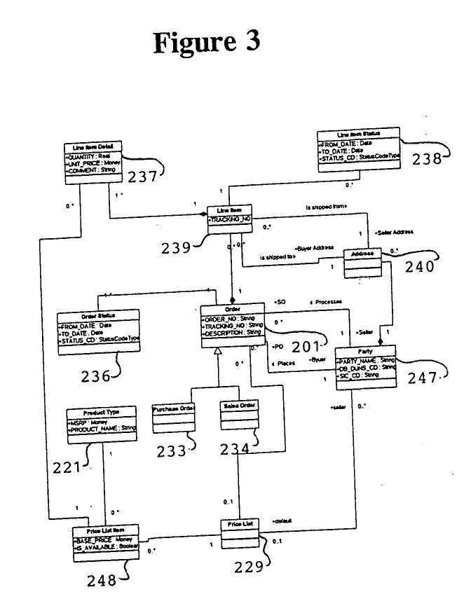

FIGS. 3-9 are UML class diagrams illustrating functionally separate portions of the high-level data model illustrated in FIG. 2. The following is the definition of each class illustrated in the Figures.

Address class 240 describes a valid address for an organization location. It is possible that an organization has more than one address (instances of Address Class 240). Each address class instance may have one or more addresses in Address Role class 241 (such as Billing, Shipping, Mailing, Contact Address, etc.). Address class 240 may have different instances of Address Structure class 243 depending on the country where the organization is located. Depending on Address Structure class 243 the Address class 240 may have a different number of instances of Address Line class 242 associated with it.

For example, XYX Inc. is a book distributor having two warehouses (one in Connecticut, another in Oklahoma). Its headquarters is located in New York City. Three physical addresses (instances of Address Class 240) are associated with it. Therefore, there are three instances of Address class 240. Products may be shipped from each of its two warehouses, so the headquarters address instance of Address Class 240 has both a Billing and Mailing instance of Address Role class 241.

Address Line class 242 is part of Address class 240. Each address line class 242 is associated with Address Structure Line class 244 of Address Structure class 243 which is associated with address class 240.

XYZ Inc. is located in the United States. The U.S. address structure (an instance of Address Structure class 243) has the following instances of Address Structure Line class 244: Street, City, State and ZIP code. Therefore, there are four instances of address line classes 242 for XYZ Inc. address class 240, e.g., 875 Spring Street #122 corresponds to the “street” address structure line (an instance of Address Structure Line class 242).

Address role class 241 defines the purpose for an address (an instance of address Class 240). Each address class may play multiple address roles in address role class 241. For example, XYZ Inc. is a book distributor having two warehouses, one in Connecticut and one in Oklahoma. Its headquarters is located in New York City. There are three physical addresses. Products may be shipped from each of its warehouses. The headquarters address plays both Billing and Mailing address roles (instances of Address Role class 241). Warehouse addresses (an instance of Address Class 240) play only a Shipping address role.

Address Structure class 243 incorporates a set of address structure lines (an instance of Address Structure Line class 244) defined so that the set of components conforms to the address of a particular high level area, e.g., country, (an instance of Area Class 246). For example, an address structure for the United States (an instance of Address Structure class 243) has four address structure lines (instances of Address Structure Line class 244), for example, city, state and zip code.

Address Structure Line class 243 is the finest component of the particular Address Structure Class 240. For example, an address structure for the United States (an instance of Address Structure class 243) has four address structure lines (instances of Address Structure class 244), for example, city, state and zip code.

Agreement Line Item class 217 contains line items of a trading partner agreement (an instance of Trading Partner Agreement class 220). Agreement line items (instances of Agreement Line Item class 217) define agreement conditions that are specific for particular product types (instances of Product Type class 221). If the agreement line item defines a price for the particular product, it overrides the corresponding default price in a price list (an instance of Price List class 229). Trading partner agreement class 220 may have associated terms (instances of Term Class 219) and exhibits (instances of Exhibit class 227) associated with it.

For example, a trading partner agreement (an instance of Trading Partner Agreement class 220) has an agreement line item (an instance of Trading Partner Agreement Line Item class 217) of “Apache Server Handbook” product type (an instance of Product Type class 221) defining the unit price for this product type to be ten dollars rather than fifteen dollars as defined as the default price (an instance of Price List Item class 229). Area class 246 describes a geographical unit and is associated with Area Type class 245. There is a hierarchy of the areas in area class 246 in the system. For example, suppose the system contains the following areas (instances of Area class 246): United States, France, Spain, Italy, Manhattan, Rome, Paris and Barcelona. The following area hierarchies will exist in the system in this case: United States→NewYork→Manhattan; France→Paris; Italy→Rome; Spain→Barcelona.

Area Type class 245 describes the type of an area (an instance of Area class 246). There is a hierarchy of area types (instances of Area Type class 245) in the system.

Each area preferably belongs to one of the instances of area type class 245. For example, the following is an area hierarchy of area types (instances of Area Type class 245) in the system: Country→State→City and Country→City.

Bank account class 225 defines a bank account of a party (an instance of Party class 247). It has an account number (global ACCT_NO object) which is an actual account number and account type whose attributes are described in a global ACCT_TYPE object as shown in Bank Account class 225. Account Type may define the category of the account (i.e., credit, debit, etc.).

For example, Party XYZ Inc. has two bank accounts. Therefore, there are two instances of Bank Account class 225. The first bank account class instance is a Credit Account having an account number of 1234567XXX25, and the second bank account class instance is a Debit Account having an account number equal to 1234567XXX26.

Buyer class 203 is a specialization of a party (an instance of Party class 247) and thus contains attributes and associations specific to the role of a buyer (an instance of Buyer class 203). For example, XYZ Inc. is a book distributor. When it buys product from vendors or from other resellers it plays the role of a buyer (an instance of Buyer class 203).

Class attribute class 211 defines class names and their text attributes that may have a static translation (an instance of Static Translation class 210). For example, global PRODUCT_NAME object shown in Product Type class 221 is an attribute of the Product Type class.

Currency class 226 defines currencies supported by the system. Sellers (instances of Seller class 202) assign currency values (instances of Currency class 226) to their price list (instance of Price List class 229). An Exchange Rate class 228 defines the Exchange Rate between currencies. For example, currencies (instances of Currency class 226) may be U.S. dollars, Italian lira or the Brazilian real.

Customer Account class 204 describes relationships between parties from Party class 247, e.g., a buyer and seller (instances of Buyer and Seller classes 203 and 202 respectively). If a seller establishes a customer account (an instance of Customer Account class 204) for its customer, the customer has the right to place orders with this particular seller.

The default price list (an instance of Price List class 229) may be assigned to the customer account (an instance of Customer Account class 204).

Prices indicated in a trading partner agreement (an instance of Trading Partner Agreement class 220) may override prices from the price list. For example, XYZ Inc. has opened customer account #789876A3 (an instance of Customer Account class 204) for the ZZZ Inc. party (an instance of Party class 247). The account is associated with price list #P77643 (an instance of Price List class 229) as well as a trading partner agreement (an instance of Trading Partner Agreement class 220).

Customer Account Rules class 224 defines rules for opening a customer account (an instance of Customer Account class 204). Each seller (an instance of Seller class 202) may have a different set of rules. For example, one customer account rule (an instance of Customer Account Rules class 224) associated with XYZ Inc. party (an instance of Party class 247) indicates the customer may require a Credit Rating greater than 75.

Discount class 235 indicates adjustment to prices (an instance of Price List Item class 248) of a specific product type (an instance of Product Type class 221) that is applied to the price listed in a price list (an instance of Price List class 229) if specific conditions are met. For example, if buyer XXX Inc. (an instance of Buyer class 203) orders more than 1,000 items of Apache Server Handbook from XYZ Inc. then it will receive a 5% discount (an instance of Discount class 235). However, if XXX Inc. orders the same items from ZZZ Inc. then it will receive a 10% discount (another instance of Discount class 235).

Exhibit class 227 describes agreement clauses regarding trading partner agreements (instances of Trading Partner Agreement class 220). For example, a trading partner agreement may specify payment within 30 days indicated in an exhibit (an instance of Exhibit class 227).

Exchange Rate class 228 defines the rate of exchange between different currencies (an instance of Currency class 226). The Exchange Rate class retains historic information since the entire transaction may not happen at the same time (e.g., items may be shipped prior to billing). For example, an exchange rate of one U.S. dollar=1.03687 Euros on 02129/00 would be an instance of Exchange Rate class 228.

Language class 212 defines human languages supported by D-NET. For example, the English, Spanish and Mandarin Chinese languages are supported by D-NET, so they are instances of Language class 212.

Line Item class 239 is part of Order class 201 and contains line items of an order (an instance of Order class 201). Line Item class 239 logically groups line item details (an instance of Line Item Detail class 237) of an order. Line Item class 239 incorporates a set of line item details identifying items to be shipped from a single seller site to a single buyer site in the same shipment.

For example, XYZ Inc. has one warehouse located in Connecticut and another in Oklahoma. Buyer ZZZ Corp. has placed an order with XYZ Inc. for 100 copies of “Harry Potter and the Order of the Phoenix” and 50 copies of “Apache Server Administrators Handbook” product types (an instance of Product Type class 221) to be shipped to a bookstore located in New York. An additional 50 copies of “Apache Server Administrators Handbook” product type are to be shipped to a bookstore in Florida. If all the books are stored in the same warehouse there will be two line items (instances of Line Item class 239): one that is shipped to New York with items of two different product types, and another shipment to Florida.

In the event that the copies of the “Harry Potter and the Order of the Phoenix” are stored in the Oklahoma warehouse and the copies of the “Apache Server Administrator's Handbook” are located in Connecticut, there will be three shipments and three corresponding line items, i.e., three corresponding instances of Line Item class 239 in the order.

Line Item Detail class 237 describes the smallest components comprising an order (an instance of Order class 201). It shows individual product types (instances of Product Type class 221) that were purchased.

One instance of Line Item Detail class 237 is line item detail for items of the same product type (an instance of Product Type class 221) that are contained in the same shipment. There can be any number of instances of Line Item detail class 237 associated with a line item (an instance of Line Item class 239).

Looking at the prior example, when the order consisted of two line items (two instances of Line Item class 239), the first line item consisted of two line item details (two instances of Line Item Detail class 237), where the first line item detail indicated 100 copies of “Harry Potter and the Order of the Phoenix” product type were ordered and the second indicated 50 copies of “Apache Server Administrator's Handbook” product type were ordered.

Line Item Detail Interface class 222 stores temporary line item details (an instance of Line Item Detail class 237) for an order (an instance of Order class 201) that has been downloaded from the D-NET system to an external system or that has been uploaded from an external system to the D-NET system.

Refer to the example for Line Item Detail class 237 for an example of Line Item Detail Interface class 222.

Line Item Interface class 207 stores temporary line items (instances of Line Item class 239) for orders that are either downloaded from this system to an external system or that are uploaded from an external system to the D-NET system. For an example refer to the example for the Line Item class.

Line Item Status class 238 describes the status of line items (instances of Line Item class 239). Line Item Status class 238 contains all of the history information about line item status changes. “in Transit,” “Cancelled” and “Completed” are instances of Line Item Status class 238.

Line Item Status Interface class 208 provides temporary storage for instances of Line Item class 239 for orders (instances of Order class 201) which may either be downloaded from the D-NET system to an external system or uploaded from an external system to the D-NET system. For an example refer to the example for Line Item class 239.

Order class 201 describes orders by which instances of Party class 247 buy and sell their products. It may comprise instances of Line Item class 239, which may be decomposed to instances of Line Item Detail class 237.

For example, XYZ Inc. has one warehouse located in Connecticut and another in Oklahoma. Buyer ZZZ Corp. has placed an order (an instance of Order class 201) with XYZ Inc. for 100 copies of “Harry Potter and the Order of the Phoenix” product type along with 50 copies of “Apache Server Administrator's Handbook” product type which may need to be shipped to a bookstore located in New York. An additional 50 copies of “Apache Server Administrator's Handbook” may need to be shipped to a bookstore in Florida.

If all the books are stored in the same warehouse there will be two instances of Line Item class 239, one indicating shipment to New York with items of two instances of Product Type class 221, and another shipment to Florida.

In the event that the copies of “Harry Potter and the Order of the Phoenix” are stored in the Oklahoma warehouse and the copies of the “Apache Server Administrator's Handbook” are located in Connecticut, there will be three shipments and three corresponding instances of Line Item class 239 in this order (an instance of Order class 201).

Order Interface class 206 describes temporary storage for instances of Order class 201 which may either be downloaded from the system to an external system or uploaded from an external system to this system. For an example refer to the example for Order class 201.

Order Status 236 describes the status of an instance of Order class 201. Order Status class 236 contains all of the historical information related to order status changes.

An order cannot be completed until all of its instances of Line Item class 239 indicate a status of either “Completed” or “Cancelled.” “In Transit,” “Cancelled” and “Completed ” are examples of instances of Order Status class 236.

Order Status Interface class 205 provides temporary storage for instances of Order Status class 236 related to instances of Order class 201 which may either be downloaded from this system to an external system or uploaded from an external system to this system.

Party class 247 describes an actor using the system. For specific transactions it may play the role of either buyer or seller (i.e., its children are Buyer and Seller classes 203 and 202 respectively). Party class 247 has one or more instances of Address class 240 and one or more instances of Bank Account class 225. As a seller it may open accounts for its customers and process buyer orders. As a buyer it may request a seller to open an account for it, or it may place the order with a particular seller.

For example, XYZ Inc. may be a book distributor. An instance of Party class 247 may be either a seller or buyer or both roles.

Party Attribute Data Domain class 232 describes the domain of values a custom attribute of an instance of Party class 247 may assume. For an example refer to the example for Product Attribute Data Domain class 215.

Party Attribute Value class 231 describes values of a custom attribute of an instance of Party class 247. For an example refer to the example of Product Attribute Value class 213.

Price List class 229 defines a set of instances of Product Type class 221 which a seller (an instance of Seller class 202) may provide and has instances of Price List Item class 248 having price and availability information. Each instance of Price List class 229 may have several instances of the Price List Item class which define prices for specific products. A seller may have several instances of Price List class 229.

Each instance of the Price List class may be related to only one seller (an instance of the Seller class). When a customer opens an account with seller the default instance of Price List class 229 may be assigned to that instance of Customer Account class 204. The prices (instances of Price List Item class 248) from an instance of Price List class 229 may be overridden by prices associated with an instance of Trading Partner Agreement class 220.

For example, XYZ Inc. has two instances of Price List class 229 for customers of different categories. The first instance may be intended for its frequent and most reliable trading partners and the second one may be for occasional customers.

Price List Item class 248 defines prices for instances of Product Type class 221 for a particular instance of Price List class 229. For example, XXX Inc. has an instance of Product Type class “Apache Server Handbook” in its instance of Price List class 229. For example, Price List Item class 248 defines the unit price for a particular instance of Product Type class 221 as 15 dollars.

Product Attribute Data Domain class 215 defines the domain of values a custom attribute of an instance of Product Type class 221 may assume. For example, a “Book” instance of Product Type class 221 has a “Cover Type” instance of Valid Product Attribute class 214. The instance of Product Attribute Data Domain class 215 for this attribute contains “Hardcover” and “Paperback” values.

Product Attribute class 213 may be a value of a custom attribute of an instance of Product Type class 221. For example, an instance of Product Attribute Value class 213 for a “Cover Type” attribute of the “Apache Server Administrator's Handbook” instance of Product Type class 221 has a “Paperback” value.

Product Category class 216 groups together instances of Valid Product Attribute class 214 which describe an instance of Product Type class 221 for a particular instance of Product Category class 216. For example, Book, CD, PC and Furniture are examples of instances of Product Category class 216.

Product Classification class 218 may be a standard product classification hierarchy and a set of corresponding Classification Codes. North American Industry Classification System (NAICS) is an example of an instance of Product Classification class 218.

Product Type class 221 defines an instance of Product Type class 221 which may be bought or sold through the system. Product Type class 221 exists in an instance of Product Category class 216, has an instance of Unit of Measurement class 270 and may have custom attributes for an instance of Product Type class 221. For example, an “Apache Server Handbook” may be a “Book” instance of Product Category class 216 has “ISBN” as a custom attribute for an instance of Product Type class 221 and 0-7645-3306-1 for an instance of Product Attribute Value class 213.

Purchase Order class 233 may be a specialization of Order class 201, (i.e., it may be a child of Order class 201). Purchase order class 233 defines a set of instances of Order class 201 attributes making sense for a buyer.

Sales order class 234 may be a specialization of Order class 201 (i.e., it may be a child of Order class 201). Sales order class 234 defines a set of instances of Order class 201 attributes making sense for a seller.

Seller class 202 may be a specialization of an instance of Party class 247 and contains seller specific attributes. One or more instances of Seller Type class 223 may categorize instances of Seller class 202. Seller class 202 may define instances of Customer Account Rule class 224 for opening accounts for its customers, e.g., an instance of Buyer class 203. For example, XYZ Inc. may be a book distributor selling its products to other resellers, bookstores, etc. Therefore, XYZ Inc. may be an instance of Seller class 202.

Seller class 223 may be the category of instances of Seller class 202. Seller Type class 223 may be a Manufacturer, Distributor, etc. Seller Type class 223 stores attributes specific to each category. An instance of Seller class 202 may be one or more instances of Seller Type class 223. For example, XYZ Inc. may be a distributor type instance of Seller Type class 223. Usually it buys books from manufacturers and resells them to reseller type instances of Party class 247.

Static Translation class 210 describes the value of particular text attributes along with the language the text may be written in. To translate the value of the attribute to another language it may be necessary to find the instance of Static Translation class 210 of the attribute associated with the desired language.

Term class 219 defines valid terms of an instance of Trading Partner Agreement class 220 with their effective dates. Instances of Term class 219 may include clauses for renewals, agreement termination, indemnification, non-competition and provisions for exclusive relationships. Instances of Term class 219 may be associated either with Trading Partner Agreement class 220 as a whole or with specific instances of Agreement Line Item class 217.

For example, an instance of Trading Partner Agreement class 220 has an instance of Agreement Line Item class 217 associated with an “Apache Server Handbook” instance of Product Type class 221. There may be an instance of Term class 219 of type “NotGreaterThan” with value equal to 10000 which define the maximum quantity of items of the given instance of Product Type class 221 in one order (one instance of Order class 201).

Trading Partner Agreement class 220 describes a trading agreement between instances of Party class 247 which may be concluded when an instance of Customer Account class 204 may be initialized or opened or at any time thereafter. Trading Partner Agreement class 220 defines terms and conditions of the buying and selling of products, goods, or services. Instances of Term class 219 (trading partner agreement terms) may be changed after one may be established. It may have a Starting Date (global FROM_DATE object) and an Ending Date (global TO_DATE object) as well.

Trading Partner Agreement class 220 defines additional conditions that instances of Party class 247 have agreed on and it may have associated instances of Agreement Line Item class which define conditions for specific instances of Product Type class 221. If an instance of Agreement Line Item class 217 contains prices for a particular product, these override default prices in the instance of the Price List class. An instance of Trading Partner Agreement class 220 may have instances of Term class 219 and Exhibit class 227 associated with it.

For example, XYZ Inc. may be a book distributor having a trading partner agreement with ZZZ Inc. (an instance of Trading Partner Agreement class 220). The trading partner agreement has line items (instances of Agreement Line Item class 217), term (an instance of Term class 219) and exhibits (an instance of Exhibit class 227). The agreement line items define specific prices for certain products, and the terms define additional constraints and conditions, which determine when these prices may be applied.

Translation Rate class 272 describes the translation between alternative instances of Units of Measurement class 270 and may be generally the ratio between values of the same amount of a particular instance of Product Type class 221 measured in units. For example, the translation of 1 inch to 1 meter may be as follows:
1 Inch/1 Meter=0.0254.

Unit of Measure class 270 defines the unit of measurement for instances of Product Type class 221. It may be a quantity attribute of the Product Type class which may be related to the unit of measure. Examples of instances of Unit of Measure class 270 are bushel and pound.

Valid Party Attribute class 230 describes valid party attributes within the D-NET system. For an example see the example for Valid Product Attribute class 214.

Valid Product Attribute class 214 defines the custom attributes of an instance of Product Type class 221. An instance of a Valid Product Attribute class for a “Book” instance of Product Category 216 are Author, Publisher, Year, ISBN, Cover Type etc.

FIG. 3 is a UML diagram illustrating the Order Management data structure of the Electronic Product Catalog, i.e., the processes of placing and tracking each order.

As shown in FIG. 3, Party class 247 plays an important role in the processes of placing and tracking orders. Party class 247 is a general abstraction for an entity which takes part in the order process. Buyer class 203 and Seller class 202 may be types of Party class 247 (i.e., the Buyer and Seller classes are children of the Party class). Address class 240 may be part of the Party class (i.e., the description of each party includes address information).

Before placing an order, a buyer (an instance of Buyer class 203) chooses a party (an instance of Party class 247) they may be willing to deal with (in this example, a seller), they may then place the order (an instance of Order class 201) provided that they already have a customer account (an instance of Customer Account class 204) established with the seller (an instance of Seller class 202). A default price list (an instance of Price List class 229) may be assigned to the customer when the seller opens a customer account.

The parties involved may have a trading partner agreement (an instance of Trading Partner Agreement class 220) which defines some unique buying conditions and may include product prices different from the default prices in the price list the seller has assigned for a particular product type (an instance of Product Type class 221).

Orders may be either purchase orders (instances of Purchase Order class 233) or sales orders (instances of Sales Order class 234), i.e., Purchase Order class 233 and Sales Order class 234 may be kinds of Order class 201.

To place an order, the buyer selects products they want to buy from the product types the seller offers among their price list items (an instance of Price List Item class 248). The shipping addresses may be grouped by delivery location, e.g., address, further defining the price list items of the order. Finally, the buyer confirms that line item details (an instance of Line Item Detail class 237) of the order are populated, thereby verifying the order.

The price for each specific product may be a base price (global object in Price List Item class 248) established by the seller, and the base price may be discounted (an instance of Discount class 235). If a trading partner agreement exists between the parties, an agreement line item (an instance of Agreement Line Item class 217) may determine the price of the specific product.

After an order is posted to the system, the seller may either approve or discard the order. The finest level of granularity in terms of order approval or discard may be a line item (an instance of Line Item class 239). If the order is approved, the seller may begin to process it.

The status of the order line items (an instance of Line Item Status 238) may come to the system through external interfaces to the seller order processing system.

The status of the order (an instance of Order Status class 236) may depend on the line item status. The order is completed when all the line items have a status of “COMPLETED.” The buyer may track the order status within the system through the use of a tracking number(s) (global object TRACKING_NO in Order class 201) provided by the seller to track orders through external systems.

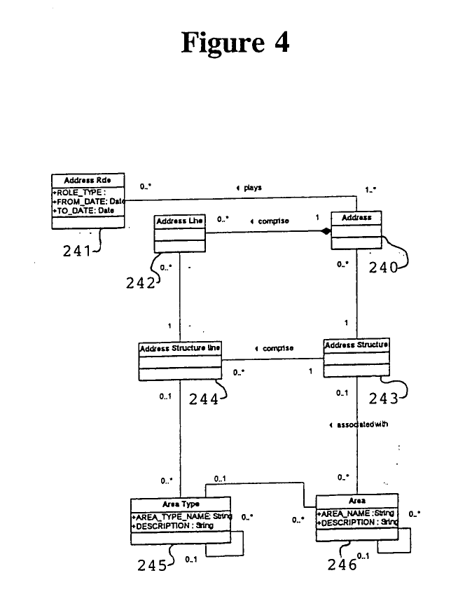

FIG. 4 is a UML diagram illustrating the address data structure of the Electronic Product Catalog for managing address information of the parties involved in a transaction.

As shown in FIG. 4, an address (an instance of Address class 240) in each country may have a different address structure (an instance of Address Structure class 243) because various sites of each party may be located in different areas (an instance of Area class 246). Area Type class 245 may describe area type (e.g., country). A U.S. address is identified through a street, city, state and zip code line (instances of Address Structure Line class 244). The information on each address may describe an Address Line class 242.

The address structure may be different in countries, which do not have States. Therefore, a high level area which does not have a parent area (“Country” area type) may have an area structure associated with it having an address structure line of another area type (such as City Type, Street Type).

The address of a party may have the address structure which is associated with the high level area (Country) where the party site is located. Each address may play a role (an instance of Address Role class 214), e.g., shipping address.

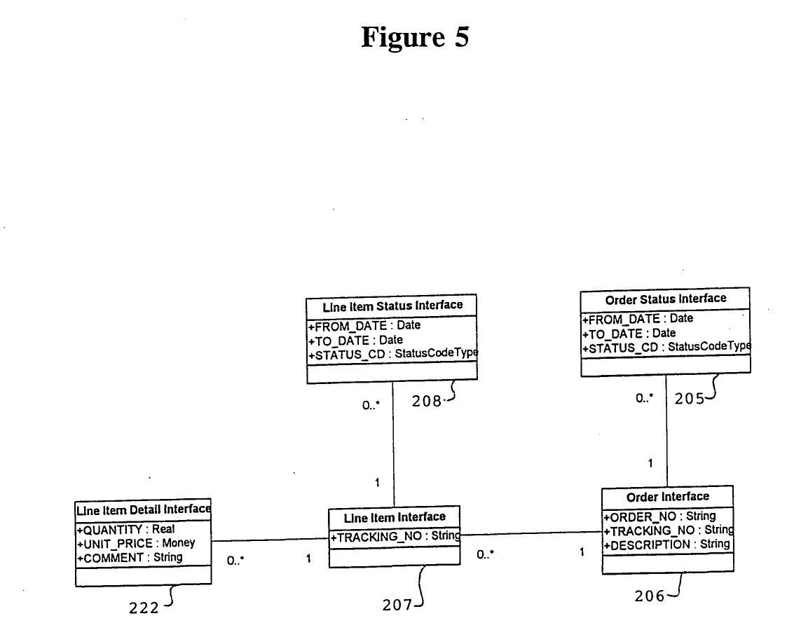

FIG. 5 is a UML class diagram illustrating external interfaces data structure of the Electronic Product Catalog for exchanging order information between the D-NET system and external systems.

As shown in FIG. 5, the order structure as it exists in the system is replicated so that each class from the order data model has a corresponding interface class. The external interface data structure stores order information, thereby acting as a cache or buffer. Order class 201 is replicated as Order Interface class 206, and Line Item class 239 is replicated as Line Item Interface class 207. Line Item Detail class 237 is replicated as Line Item Detail Interface class 222, and Order Status class 236 is replicated as Line Item Status Interface 208.

When order data is either downloaded from or uploaded to the system, these interface structures may have to be cleared out and the populated with the desired order data. In case the data is uploaded to the system from an external source, the application may populate interface tables with the order data of the external orders. Loaded data may be validated after uploading is completed.

The correct order information may then be used to either insert new order(s) to the system or update existing order information. In case order information is downloaded from the system, the application may populate the interface tables with downloaded information (taking it from the order structure) and then depending on the external system requirements, to download the data in the file having the desired data format.

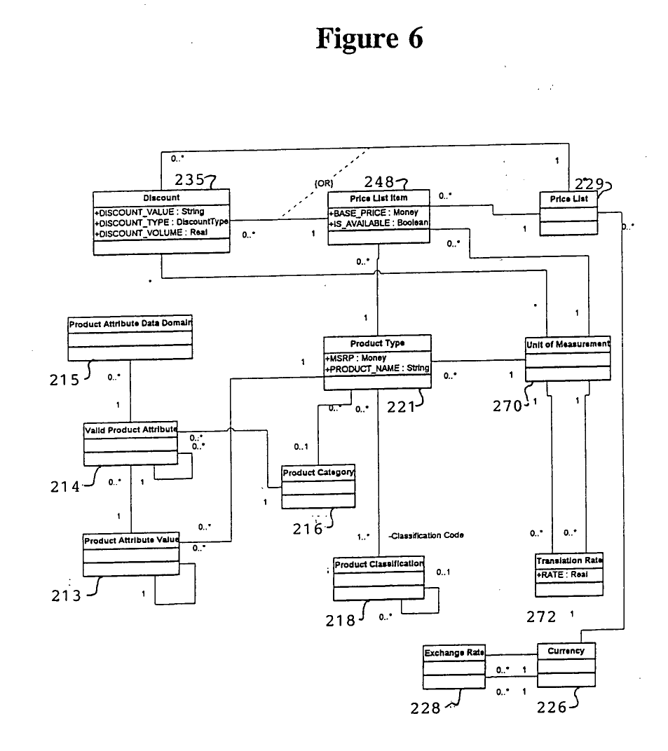

FIG. 6 is a UML class diagram illustrating the product attributes and price list data structure of the Electronic Product Catalog for storing information about arbitrary products and services in the system.

As shown in FIG. 6, each product type (an instance of Product Type class 221) may be associated with a unit of measurement (an instance of Unit of Measurement class 270), and the units of measurement may have a translation rate (an instance of Translation class 272) associated therewith to convert between units. One or more product classifications (instances of Product Classification class 218) may be associated with the product type. The product attributes model has an extensible structure making it possible to define new types of attributes for the product type if necessary. The set of custom attributes for the product type may be defined by the Product Category class 216 associated with it.

To create a non-standard product attribute, create a new valid product attribute (an instance of Valid Product Attribute class 214) defining an attribute name, datatype and relationship with other attributes of this product if they exist and a product attribute data domain (an instance of Product Attribute Data Domain class 215) defining valid values of valid product attribute (an instance of Valid Product Attribute class 214). Subsequently, a product attribute value (an instance of Product Attribute Value class 213) may be assigned.

When a seller publishes data about its products a check may be made to determine if another seller has already published information for this product type (an instance of Product Type class 221). If the information about the product type has not been published then a new product type may be created.

As soon as the new product type is created it may be defined as a price list item (an instance of Price List Item class 248) in any number of price lists (instances of Price List class 229) of different sellers. The price list item may have a discount (an instance of Discount class 235) associated with it. Additionally, the price list may have currency (an instance of Currency class 226) associated with it, and the currency may have an exchange rate (an instance of Exchange Rate class 228) associated therewith.

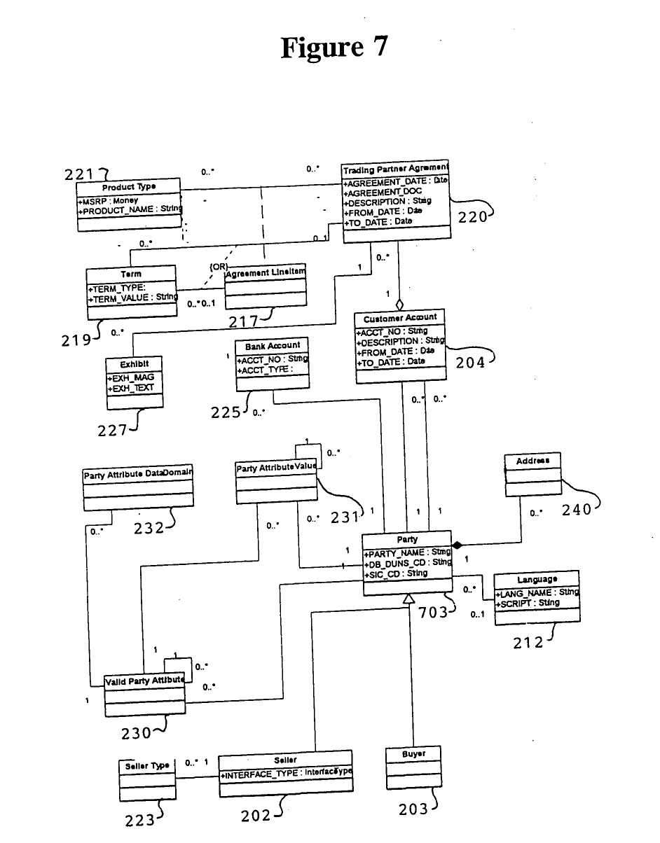

FIG. 7 is a UML class diagram illustrating a buyer and seller preferences data structure of the Electronic Product Catalog.

As shown in FIG. 7, buyer (an instance of Buyer class 203) and seller (an instance of Seller class 202) preferences may define general party (an instance of Party class 247 for a seller or buyer) preferences such as bank account (an instance of Bank Account class 225) numbers (global ACCT_NO object shown in Bank Account class 225), SIC code (global SIC_CD object shown in Party class 247), seller type (an instance of Seller class 223), customer account rules (an instance of Customer Account rules class 224), as well as specific preferences for either buyer or seller. Seller and buyer are the specializations of Party class 247 and may have their own attributes along with general party attributes.

Seller may open customer accounts (instances of Customer Account class 204) for its customers (buyers) which may play the role of the customer profile and may create trading partner agreements (instances of Trading Partner Agreement 220) which may define terms (an instance of Term class 219) or conditions (instances of Agreement Line Item class 217) of the trading agreement between the seller and buyer. These preferences may be used later during the Order Management process as discussed above.

Trading partner agreements may have product types (instances of Product Type class 221) and exhibits (instances of Exhibit class 227) associated with them as well. The Buyer class 712 may categorize buyers.

New attributes for the party may be created by creating a valid party attribute (an instance of Valid Party Attribute class 230) which may define the attribute Name, Datatype and relationship with other attributes for the party if required for each non-standard PARTY attribute. A party attribute data domain (an instance of Party Attribute Data Domain class 232) defining valid values for the valid party attribute may additionally be defined. Subsequently, a party attribute value (an instance of Party Attribute Value class 231) may be assigned to the attribute.

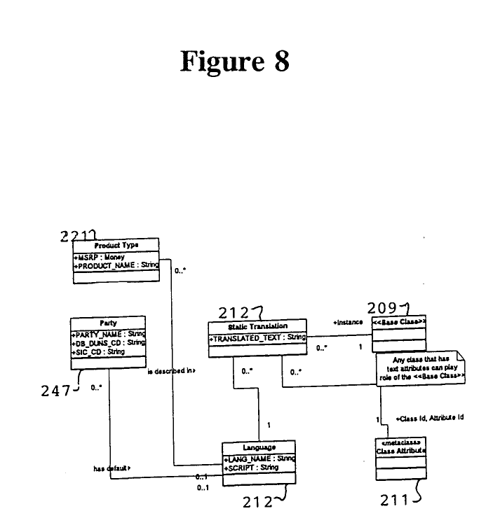

FIG. 8 is a UML class diagram illustrating a multilingual support data structure of the Electronic Product Catalog.

As shown in FIG. 8, text data may be stored in one of the supported languages (instances of Language class 212). A Base Class 209 represents text which may be associated with Static Translation class 210. There may be multiple static translations (instances of Static Translation class 210) between languages and text, up to one for each language supported. The classes and attributes, which may be translated, may be registered with Class Attribute metaclass 211. Party 247 may have an associated default language. Additionally, Language class may be associated with Product Type class 221.

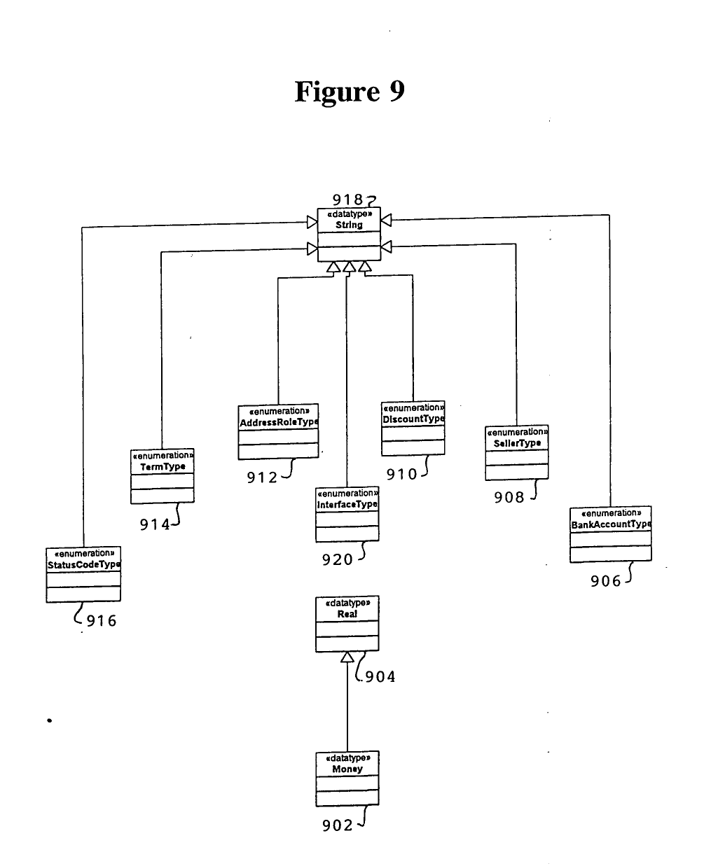

FIG. 9 is a UML class diagram of the primary data types supported by the Electronic Product Catalog.

As shown in FIG. 9, Money class 902 is a kind of Real class 904, i.e., the Money class is a child of the Real Class. StatusCodeType, TermType, AddressRoleType, InterfaceType, DiscountType, SellerType and BankAccountType classes 916, 914, 912, 920, 910, 908 and 906 respectively are types of String class 918, (i.e., they are all children of the String class).

Six classes of subscriber/users are envisioned. These are broadly defined as sellers, buyers, carriers, market data subscribers, government agencies and information providers.

Sellers may be herein defined as any manufacturer, exporter, distributor, broker or trade association that publishes listings of goods and services to the Electronic Product Catalog on the system.

Buyers may be herein defined as any importer, distributor, export agent, re-marketer or end-user organization that, having viewed and selected one or more products or services from the Electronic Product Catalog, express their intent to purchase these items by electronically submitting a purchase request or purchase order to the seller.

Carriers may be herein defined as any land, sea or air carrier or licensed freight forwarder which transports or ships goods.

Market data subscribers will subscribe to obtain standard or customized reports or to query the system for market data.

Government agencies may be herein defined as the procurement agencies of local, regional or national governments.

Information providers will provide data feeds, news, research and information which may be accessed by a subscriber.

Documents may be herein defined as electronic forms used by the system conforming to international and United States laws governing electronic commerce and which may be intended to have the same acceptance and legal standing as a written instrument.

Buyers who specify a particular product or class of products may establish conditions for purchase, such as price, and receive notification when the conditions are met or when changes in conditions occur. Access-control lists may be used for multi-level access to catalog information.

Buyers who, having viewed and selected one or more products and services that they may be interested in purchasing, may electronically send a uniquely numbered purchase order request document to the seller if no customer account exists with seller or if additional information is needed from seller before a purchase decision may be made. Such a purchase request may contain items such as special quantities, trade zones, insurance, shipping instructions, credit/payment information, buyer identification information, product availability, request for credit, banking details and other information.

Seller may electronically receive and respond to the purchase request with a corresponding uniquely numbered seller response document providing requested information to the buyer. The seller response document may request or specify additional information from a buyer, e.g., export credit insurance, letter of credit, payment or shipper information.

Buyer may respond with a corresponding purchase request providing the requested data. Seller may additionally authorize that a uniquely numbered customer account including variables such as credit limit be established against which purchase order documents may be issued.

Sellers or buyers may issue shipping/forwarding rate request documents to prospective carriers in order to obtain quotations on packaging, freight costs and other charges.

Buyers, having obtained quotations for both product cost and shipping charges may arrive at their total landed (delivered) cost by requesting a total landed cost calculation from the system.

The landed cost calculation may begin with a conversion of product cost in U.S. dollars to the local currency based on an exchange rate calculation performed on an application server 102 computer. The system may provide a harmonized tariff number and rate of duty based on a calculation performed on application server 102.

The system may calculate the duty payable and any value-added taxes to arrive at the tax-paid value (TPV) based on calculations performed on an application server 102. Finally, the system may add delivery charges from warehouse to the final destination in order to provide buyer with a total landed cost based on calculations performed on an application server 102. Buyers may use the system to calculate total landed cost for equivalent products originating in different countries. Total landed cost calculations may be run before or after shipping and forwarding rate requests may be sent to prospective carriers. The actual number and sequence of calculations required in order to arrive at the total landed cost will vary by country but are performed on the application server 102.

All goods and services regardless of their country or origin may be quoted in U.S. dollars in the system. All goods and services may also be quoted in local currency by using prevailing exchange rates to calculate to and from the local currency at the application server.

Seller may specify in the customer account which goods and services each buyer is authorized to purchase in addition to account variables such as credit limit.

Upon receipt of a uniquely numbered purchase order document from a buyer, seller has the option of final acceptance or, alternatively, notification to buyer (using the seller response document) indicating the purchase order should be modified in some way before final acceptance may occur. A uniquely numbered order confirmation document may be sent to confirm receipt and acceptance of an order.

Buyer may use the seller request to obtain a uniquely numbered blanket purchase order from seller against which individual purchase orders may be issued.

Upon partial or complete shipment of goods specified in an open purchase order by a U.S.-based seller, the system may transmit a uniquely numbered transaction data message using EDIFACT to U.S. Government systems in development including the Automated Export System (AES), Automated Commercial Environment (ACE) or International Trade Data System (IDTS). These systems are being designed to permit the electronic filing of export data to United States Customs and other U.S. Federal Government agencies.

In the event that a suitable interface to these systems is unavailable due to work-in-progress of one or more of these systems, the system will permit the seller to use their existing interface to the U.S. Customs Service to prepare shipping documents. When a complete or partial shipment of goods takes place, the seller or their agent may notify the system to generate a ship notification document electronically transmitted to the buyer.

Upon receipt of a uniquely numbered purchase order by a seller based in another subscribing country, the system may generate and send the aforementioned order confirmation message to the buyer.

When notified by the seller or their agent of a complete or partial shipment of goods or an open purchase order, the system may provide an interface and uniquely numbered transaction data message to the U.S. Customs Service of that country permitting the electronic filing of shipping documents. A ship notification message may be sent to the buyer also.

The system may either input a purchase order to standard or customized supply chain management operating at a D-NET site or translate the order to XML, EDIFACT or X.12 for transmission to seller. Buyers may request modifications to or cancellation of an existing purchase order by submitting a uniquely numbered order revision request document to seller. Seller may respond using a seller response or a uniquely numbered purchase order modification document depending upon whether changes to the order revision request are accepted or require further revision.

The system may provide order tracking to buyers and sellers for goods in transit upon receipt of an order transit status request document. The system may respond with an order transit status document message.

The system may obtain the order transit status information by means of electronic links to carrier order tracking systems.

For goods being imported into the United States, the system may provide interfaces to the U.S. Government Automated Commercial System (ACS) and Automated Broker Interface (ABI). ACS is the system used by the U.S. Customs Service to track, control and process all commercial goods entering the U.S. ABI is a component of ACS which allows importers to file import data electronically with the U.S. Customs Service. ABI enables U.S. Customs Service declarations to be processed electronically with a number of other functions. The system may also support the Automated Clearinghouse (ACH) electronic payment option enabling buyers and importers to pay customs fees, duties and taxes with one electronic transaction.

For goods being imported into other countries in which D-NET is deployed, the system may use EDIFACT syntax to describe customs declaration and invoice data.

Upon release from U.S. Customs and acceptance of goods by a buyer or their agent in the United States or other countries in which D-NET is deployed, the commercial invoice and other required documentation is transmitted to buyer bank and buyer account is debited. Buyer bank will, assuming it maintains an internal account with seller bank, credit this account. A SWIFT transaction message may be sent to seller bank debiting the internal buyer bank account and crediting the seller account. D-NET sites maintain interfaces with the SWIFT network in order to present commercial invoices and related documents to SWIFT member banks.

In the event that both buyer and seller maintain accounts with U.S.-based banks, the system may issue a request to buyer's bank to transfer funds to seller's bank using Fedwire.

The system may maintain transaction histories for subscriber accounts in accordance with U.S. and international record-keeping requirements. The system maintains a distributed database containing transaction data which market data subscribers and other classes of subscribers may access using a D-NET connection.

The system may provide order-input data to a subscribing organization supply chain management application in two ways. The first is to input orders processed by the system to standard or customized commercial supply chain management software located at a D-NET site. The second is to translate the order to EDIFACT, XML or X.12 format for transmission to the seller.

National Procurement and Resource Management System (NPRM), is a publish and subscribe D-NET application that may facilitate the publication/distribution of government agency requests for proposals and vendor responses to them.

This application allows government agencies to publish RFPs for distribution to select vendors, perhaps within a country or locality, or to publish them without restrictions. For example, a vendor might be allowed to subscribe to an agency bid list and receive bid documents automatically.

NPRM also permits government agencies to search all Seller electronic product catalogs published on the system for product information. Sellers who receive purchase orders from government agencies using NPRM may file them using the same order processing and payment methods described earlier in the description of this system.

Both VOTE and NPRM will use similar application server and database data models to support multilingual, multi-country and multi-customer operation. Both NPRM and VOTE allow for real-time translation between languages using a combination of hard-coded translation values for standard words and reference values and commercial translating utilities for free-form text.

Multi-customer operation may be provided through implementation of customer tables pointing to the catalog inventory and transaction elements of the database. Implementing customer preferences, as may be required by trading partner agreements, enables multilevel access to seller catalog information. VOTE and NPRM may support a flexible, complex inventory system capable of classifying catalog inventory items in different units.

VOTE and NPRM may support many types of merchandise transfer. Under the generic term merchandise transfer, VOTE and NPRM may support the aforementioned purchase request, purchase order, order confirmation, blanket purchase order and ship notification documents.

VOTE and NPRM may support transactions in U.S. dollars and local currencies. Exchange rate conversions may be supported for total landed (delivered) cost calculations and purchase orders.

VOTE and NPRM may support access-control lists, which control the explicit access permissions granted to users and groups.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A method for creating and searching an Electronic Catalog, comprising the steps of:
receiving item information through a network into an electronic catalog,
placing the item into categories based on standard classification codes, and
associating a country where the item resides to the item in the electronic catalog.

2. The method of claim 1, further comprising the steps of:
receiving a search request through the network containing a standard classification code, and
returning, through the network, items within the standard classification code.

3. The method of claim 2, further comprising the steps of:
receiving, through the network, a subset of items within the standard classification code within the country to be searched.

4. The method of claim 2, further comprising the step of:
displaying, through the network, the items returned.

5. The method of claim 3, further comprising the step of:
Displaying, through the network, the subset of items returned.

6. The method of claim 1, further comprising the steps of:
Determining trade costs associated with the item,
Adding the trade costs to the cost of the item resulting in the total landed cost of the item, and
returning, through the network, the total landed cost of the item.

7. The method of claim 6, further comprising the steps of:
Receiving, through the network, identity of the country the item is to be shipped from and identity of the country the item is to be shipped to, and
Receiving, through the network, type of currency the requester prefers and type of currency the seller prefers.

8. The method of claim 7, further comprising the steps of:
performing an exchange rate calculation using the initial cost of the item and the type of currency the requester prefers and the type of currency the seller prefers,
determining tariff for the item based on the country the item is to be shipped from and the country the item is to be shipped to,
determining delivery costs associated with the item based on the country the item is to be shipped from and the country the item is to be shipped to,
calculating value for the duty to be added to the initial cost based on the country the item is to be shipped from and the country the item is to be shipped to,
calculating value added taxes based on the country the item is to be shipped from and the country the item is to be shipped to, and,
arriving at the total landed cost by adding to the total initial cost the value for the duty, the value added taxes, the tariff and the delivery costs.

9. The method of claim 8, further comprising the step of:
Displaying, through the network, the total landed cost.

10. The method of claim 1, wherein the item is a service.

11. The method of claim 1, wherein the item is a product.

12. The method of claim 1, wherein the electronic catalog is a database.

13. A system for facilitating worldwide commercial business to business and Government electronic commerce based on national deployment, said system comprising:
a dedicated network coupling a plurality of country specific systems; and
a plurality of country specific systems, each of the plurality of country specific systems including:
an application server computer;
a data server computer having a database containing subscriber information and country trade variables, said data server computer being connected to said application server computer; and
An electronic commerce program, residing within said application server, for facilitating country to country trade.

14. The system of claim 13, wherein said electronic commerce program further comprises:
means for determining trade costs associated with an item.

15. The system of claim 14, wherein said electronic commerce program comprises:
means for receiving identity of a country the item is to be shipped from and identity of a country the item is to be shipped to; and
means for receiving type of currency the requester prefers and type of currency the seller prefers.

16. The system of claim 15, wherein said electronic commerce program further comprises:
means for performing an exchange rate calculation using the initial cost of the item and the type of currency the requester prefers and the type of currency the seller prefers;
means for determining tariff for the item based on the country the item is to be shipped from and the country the item is to be shipped to;
means for determining delivery costs associated with the item based on the country the item is to be shipped from and the country the item is to be shipped to;
means for calculating value for the duty to be added to the initial cost based on the country the item is to be shipped from and the country the item is to be shipped to;
means for calculating value added taxes based on the country the item is to be shipped from and the country the item is to be shipped to; and
means for arriving at a total landed cost by adding to the total initial cost the value for the duty, the value added taxes, the tariff and the delivery costs.

17. The system of claim 16, wherein said electronic commerce program comprises:
means for returning, through the network, total landed cost of the item.

18. The system of claim 12, wherein country trade variables comprise a tariff, a value added tax, a delivery cost, trading partner agreements, and a duty.
